(19) United States
(12) Patent Application Publication
(10) Pub. No.: US 2014/0279534 A1
(43) Pub. Date: Sep. 18, 2014

(54) SYSTEM AND METHOD FOR PROVIDING AN ACCOUNT HOLDER A NOTIFICATION

(71) Applicant: Capital One Financial Corporation, McLean, VA (US)

(72) Inventor: Anthony P. MILES, Henrico, VA (US)

(73) Assignee: Capital One Financial Corporation, McLean, VA (US)

(21) Appl. No.: 14/204,196

(22) Filed: Mar. 11, 2014

Related U.S. Application Data
(60) Provisional application No. 61/778,846, filed on Mar. 13, 2013.

(51) Int. Cl. G06Q 20/42; G06Q 20/40

(52) U.S. Cl. CPC G06Q 20/42; G06Q 20/4016
USPC 705/44

(57) ABSTRACT

Systems and methods provide for notifying an account holder of an attempted transaction. The systems and methods include a transaction data communication module that receives, via a network, transaction data associated with a transaction, a transaction processor that associates the transaction data with an account of an account holder, compares the transaction data to one or more spending limits associated with the account, and compares the transaction data to one or more fraud detection rules associated with the account, an account holder notification system associated with the transaction processor that notifies the account holder, via a network, based on the results of the comparison steps, and an authorization response module that receives, via a network, a response from the account holder and approves or deny the transaction based at least in part on a response received.

### CROSS-REFERENCE TO RELATED APPLICATIONS

This application contains subject matter related to and claims the benefit of U.S. Provisional Patent Application No. 61/778,846, filed on Mar. 13, 2013, the entire contents of which is incorporated by reference.

### FIELD OF THE DISCLOSURE

The present disclosure relates to systems and methods for providing notifications to account holders.

### BACKGROUND OF THE DISCLOSURE

Fraud departments decline transactions and use the telephone or email to contact customers after the fact to request validation of the transaction. These customer service inquiries do not approve the transaction, but instead verify that the account has not been compromised. Also, if a preset spending limit has been imposed on an account due to a credit limit or an available balance and a transaction would exceed the limit, the transaction is declined and some accounts can exceed their limit and incur an over limit fee or overdraft fee. But existing notification systems do not enable real-time interaction to authorize a potentially invalid transaction.

These and other drawbacks exist.

### SUMMARY OF THE DISCLOSURE

The various embodiments of the disclosure provide systems and methods for notifying account holders about transactions and enabling authorization of those transactions. A system includes a transaction data communication module that receives, via a network, transaction data associated with a transaction, a transaction processor that associates the transaction data with an account of an account holder, compares the transaction data to one or more spending limits associated with the account, and compares the transaction data to one or more fraud detection rules associated with the account, an account holder notification system associated with the transaction processor that notifies the account holder, via a network, based on the results of the comparison steps, and an authorization response module that receives, via a network, a response from the account holder and approves or deny the transaction based at least in part on a response received.

A method includes receiving, via a network, transaction data associated with a transaction, associating, using a transaction processor, the transaction data with an account of an account holder, comparing, using the transaction processor, the transaction data to one or more spending limits associated with the account, comparing, using the transaction processor, the transaction data to one or more fraud detection rules associated with the account, notifying, using an account holder notification system, the account holder, via a network, based on the results of the comparison steps, and receiving, via a network, a response from the account holder, approving or denying the transaction based at least in part on a response received.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for providing a notification to an account holder based on an attempted transaction;

FIG. 2 depicts an example embodiment of a point of sale system utilized with a system for providing a notification to an account holder based on an attempted transaction;

FIG. 3 depicts an example embodiment of a system for providing a notification to an account holder based on an attempted transaction;

FIG. 4 depicts an example embodiment of a method of providing a notification to an account holder based on an attempted transaction; and

FIG. 5 depicts an example embodiment of a method of providing a notification to a primary account holder based on an attempted transaction by a secondary account holder.

### DETAILED DESCRIPTION OF THE EMBODIMENTS

The following description is intended to convey a thorough understanding of the embodiments described by providing a number of specific example embodiments and details involving systems and methods for notifying an account holder in response to one or more transactions. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

According to the various embodiments of the present disclosure, systems and methods for providing real-time notifications to an account holder based on one or more transactions. For example, an account holder may purchase a TV at a merchant point of sale (POS) location using a credit card. For example, the transaction data may be run through a fraud algorithm to check for fraud indicators. The transaction data also may be compared to the credit balance for the account. The transaction data may be compared to pre-set limit thresholds. If the transaction data triggers one or more of these indicators or checks, an electronic notification may be sent to the account holder. In the various examples, the notification may sent to the account holder's mobile device. The notification may inform the account holder of the attempted transaction and request approval or denial. The account holder may choose to authorize the transaction by affirmatively responding to the notification. The account holder may choose to deny the transaction.

In the various examples, a primary account holder may have previously given a secondary account holder access to the account. The primary account holder may have pre-set limits on the account, such as a limit on the amount the secondary account holder can purchase in a day, or a per-transaction limit on the purchase amount by the secondary account holder. For example, the secondary account holder may be limited to a $500 credit limit and/or a $15 per transaction limit. These limits would, for example, enable the primary account holder to provide the secondary account holder with a mechanism for paying for a meal and avoid the risk that the secondary account holder would make a larger purchase. If the secondary account holder makes a purchase that exceeds one or more limits, the primary account holder may receive a notification requesting authorization of the attempted transaction. The primary account holder may choose to authorize the transaction by affirmatively responding to the notification.

The systems and methods described herein may work in real-time, such as at the moment a transaction is attempted using one or more accounts.

FIG. 1 depicts an example embodiment of a system 100 for notifying an account holder based on transaction information. The system 100 may include various network-enabled computer systems, including, as depicted in FIG. 1 for example, a financial institution 101; an account holder notification system 102 comprising a transaction processor 103, a fraud processor 104, and an account holder notifier 105. In the example embodiment shown in FIG. 1, account holder notification system 102 may be separate from financial institution 101. Account holder notification system 102 also may be integrated into financial institution 101. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to notify an account holder based on transaction information. The depiction in FIG. 1 is an example only, and the functions and processes described herein may be performed by any number of network-enabled computers as part of a system for notifying an account holder based on a transaction that has exceeded certain limits. Also, system 100 illustrates only a single instance of each component. It will be appreciated that multiple instances of these components may be used. Moreover, the system 100 may include other devices not depicted in FIG. 1.

In various example embodiments, an account holder 106 may be any individual or entity that desires to conduct a financial transaction using one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account card may be associated or affiliated with one or more social networking sites, such as a co-branded credit card.

In various example embodiments, a merchant 107 may be any retailer, wholesaler, point-of-sale (POS) location, or any other provider of goods or services. Merchant 107 may have one or more physical locations. Merchant 107 may be an online retailer. Merchant 107 may be any commercial or business entity where account holder 106 purchases goods or services using one or more financial accounts with financial institution 101.

Network 108 may enable communication between financial institution 101, account holder notification system 102, one or more account holders 106, and one or more merchants 107. For example, Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the exemplary types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

As used herein, the term mobile device may be, for example, a handheld PC, a phone, a smartphone, a PDA, a tablet computer, or other device. The mobile device may include Near Field Communication (NFC) capabilities, which may allow for communication with other devices by touching them together or bringing them into close proximity. Example NFC standards include ISO/IEC 18092:2004, which defines communication modes for Near Field Communication Interface and Protocol (NFCIP-1). For example, a mobile device may be configured using the Isis Mobile Wallet™ system, which is incorporated herein by reference. Other example NFC standards include those created by the NFC Forum.

As described in reference to FIG. 1, financial institution 101 may provide an account holder 106 with one or more financial accounts. The financial account may be associated with the account holder's one or more mobile devices. The mobile device may be configured to act as a method of payment at a POS location (merchant 107) using, for example, NFC or any other mobile payment technology. When account holder 106 uses his mobile device at a POS location to perform a financial transaction, the financial transaction may be charged to the mobile payment account. For example, the account holder 106 may use the device in lieu of a credit card to make a purchase merchant 107. The purchase would then be charged to the mobile payment account associated with the account holder device 106. The mobile payment account may be stored in a mobile payment account database at financial institution 101. The account may be a traditional credit card account where the account holder uses a credit card, rewards card, debit card, or similar method of payment to purchase goods and services from one or more merchants 107.

FIG. 2 depicts an example Point of Sale (PoS) device 200. PoS device 200 may provide the interface at what a customer or end user makes a payment to the merchant in exchange for goods or services. PoS device 200 also may provide transaction data about an attempted transaction to a financial institution so that the financial institution may authorize the transaction. PoS device 200 may include and/or cooperate with weighing scales, scanners, electronic and manual cash registers, electronic funds transfer at point of sale (EFTPOS) terminals, touch screens and any other wide variety of hardware and software available for use with PoS device 200. PoS device 200 may be a retail point of sale system and may include a cash register and/or cash register-like computer components to enable purchase transactions. PoS device 200 also may be a hospitality point of sale system and include computerized systems incorporating registers, computers and peripheral equipment, usually on a computer network to be used in restaurant, hair salons, hotels or the like. PoS device 200 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 200 also may be a cloud-based point of sale system that can be deployed as software as a service, which can be accessed directly from the Internet using, for example, an Internet browser.

Referring to FIG. 2, an example PoS device 200 is shown. PoS device 200 may include a controller 202, a reader interface 204, a data interface 206, a smartcard reader 208, a magnetic stripe reader 210, a near-field communications (NFC) reader 212, a power manager 214, a keypad 216, an audio interface 218, a touchscreen/display controller 220, and a display 222. Also, PoS device 200 may be coupled with, integrated into or otherwise connected with a cash register/retail enterprise system 224.

In various embodiments, Controller 202 may be any controller or processor capable of controlling the operations of PoS device 200. For example, controller 202 may be a Intel® 2nd Generation Core™ i3 or i5 or Pentium™ G850 processor or the like. Controller 202 also may be a controller included in a personal computer, smartphone device, tablet PC or the like.

Reader interface 204 may provide an interface between the various reader devices associated with PoS device 200 and PoS device 200. For example, reader interface 204 may provide an interface between smartcard reader 208, magnetic stripe reader 210, NFC reader 212 and controller 202. In various embodiments, reader interface 204 may be a wired interface such as a USB, RS232 or RS485 interface and the like. Reader interface 204 also may be a wireless interface and implement technologies such as Bluetooth, the 802.11(x) wireless specifications and the like. Reader interface 204 may enable communication of information read by the various reader devices from the various reader devices to PoS device 200 to enable transactions. For example, reader interface 204 may enable communication of a credit or debit card number read by a reader device from that device to PoS device 200. In various embodiments, reader interface 204 may interface between PoS device 200 and other devices that do not necessarily “read” information but instead receive information from other devices.

Data interface 206 may allow PoS device 200 to pass communicate data throughout PoS device and with other devices including, for example, cash register/retail enterprise system 224. Data interface 206 may enable PoS device 200 to integrate with various customer resource management (CRM) and/or enterprise resource management (ERP) systems. Data interface 206 may include hardware, firmware and software that make aspects of data interface 206 a wired interface. Data interface 206 also may include hardware, firmware and software that make aspects of data interface 206 a wireless interface. In various embodiments, data interface 206 also enables communication between PoS device other devices.

Smartcard reader 208 may be any electronic data input device that reads data from a smart card. Smartcard reader 208 may be capable of supplying an integrated circuit on the smart card with electricity and communicating with the smart card via protocols, thereby enabling read and write functions. In various embodiments, smartcard reader 208 may enable reading from contact or contactless smart cards. Smartcard reader 208 also may communicate using standard protocols including ISO/IEC 7816, ISO/IEC 14443 and/or the like or proprietary protocols.

Magnetic stripe reader 210 may be any electronic data input device that reads data from a magnetic stripe on a credit or debit card, for example. In various embodiments, magnetic stripe reader 210 may include a magnetic reading head capable of reading information from a magnetic stripe. Magnetic stripe reader 210 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments.

NFC reader 212 may be any electronic data input device that reads data from a NFC device. In an exemplary embodiment, NFC reader 212 may enable Industry Standard NFC Payment Transmission. For example, the NFC reader 212 may communicate with a NFC enabled device to enable two loop antennas to form an air-core transformer when placed near one another by using magnetic induction. NFC reader 212 may operate at 13.56 MHz or any other acceptable frequency. Also, NFC reader 212 may enable a passive communication mode, where an initiator device provides a carrier field, permitting answers by the target device via modulation of existing fields. Additionally, NFC reader 212 also may enable an active communication mode by allowing alternate field generation by the initiator and target devices.

In various embodiments, NFC reader 212 may deactivate an RF field while awaiting data. NFC reader 212 may receive communications containing Miller-type coding with varying modulations, including 100% modulation. NFC reader 212 also may receive communications containing Manchester coding with varying modulations, including a modulation ratio of approximately 10%, for example. Additionally, NFC reader 212 may be capable of receiving and transmitting data at the same time, as well as checking for potential collisions when the transmitted signal and received signal frequencies differ.

NFC reader 212 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 212 may be able to utilize transmission protocols and methods that are developed in the future using other frequencies or modes of transmission. NFC reader 212 also may be backwards-compatible with existing payment techniques, such as, for example RFID. Also, NFC reader 212 may support transmission requirements to meet new and evolving payment standards including internet based transmission triggered by NFC. In various embodiments, NFC reader 212 may utilize MasterCard's® PayPass and/or Visa's® PayWave and/or American Express'® ExpressPay systems to enable transactions.

Although not shown and described, other input devices and/or readers, such as for example, barcode readers and the like are contemplated.

Power manager 214 may be any microcontroller or integrated circuit that governs power functions of PoS device 200. Power manager 214 may include, for example, firmware, software, memory, a CPU, a CPU, input/output functions, timers to measure intervals of time, as well as analog to digital converters to measure the voltages of the main battery or power source of PoS device 200. In various embodiments, Power manager 214 remain active even when PoS device 200 is completely shut down, unused, and/or powered by the backup battery. Power manager 214 may be responsible for coordinating many functions, including, for example, monitoring power connections and battery charges, charging batteries when necessary, controlling power to other integrated circuits within PoS device 200 and/or other peripherals and/or readers, shutting down unnecessary system components when they are left idle, controlling sleep and power functions (on and off), managing the interface for built-in keypad and trackpads, and/or regulating a real-time clock (RTC).

Keypad 216 may any input device that includes a set of buttons arranged, for example, in a block or pad and may bear digits, symbols and/or alphabetical letters. Keypad 216 may be a hardware-based or mechanical-type keypad and/or implemented in software and displayed on, for example, a screen or touch screen to form a keypad. Keypad 216 may receive input from a user that pushed or otherwise activates one or more buttons on keypad 216 to provide input.

Audio interface 218 may be any device capable of providing audio signals from PoS device 200. For example, audio interface may be a speaker or speakers that may produce audio signals. In various embodiments, audio interface 218 may be integrated within PoS device 200. Audio interface 218 also may include components that are external to PoS device 200.

Touchscreen/display control 220 may be any device or controller that controls an electronic visual display. Touchscreen/display control 220 may allow a user to interact with PoS device 200 through simple or multi-touch gestures by touching a screen or display (e.g., display 222). Touchscreen/display control 220 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 220 may receive inputs from the touchscreen and process the received inputs. Touchscreen/display control 220 also may control the display on PoS device 200, thereby providing the graphical user interface on a display to a user of PoS device 200.

Display 222 may be any display suitable for a PoS device. For example, display 222 may be a TFT, LCD, LED or other display. Display 222 also may be a touchscreen display that for example allows a user to interact with PoS device 200 through simple or multi-touch gestures by touching a screen or display (e.g., display 222). Display 222 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 222 may receive inputs from control gestures provided by a user. Display 222 also may display images, thereby providing the graphical user interface to a user of PoS device 200.

Cash register/retail enterprise system 224 may me any device or devices that cooperate with PoS device 200 to process transactions. Cash register/retail enterprise system 224 may be coupled with other components of PoS device 200 via, for example, a data interface (e.g., data interface 206) as illustrated in Figure Y. Cash register/retail enterprise system 224 also may be integrated into PoS device 200.

In various embodiments, cash register/retail enterprise system 224 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 224 may comprise an retail enterprise system and/or a customer relationship management system. Retail enterprise system 224 may enable retain enterprises to manage operations and performance across a retail operation. Retail enterprise system 224 may be a stand-alone application in, for example, individual stores, or may be interconnected via a network. Retail enterprise system 224 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 224 also may include inventory control and tracking capabilities, reporting tools, customer management capabilities, employee management tools, and may integrate with other accounting software.

In various embodiments cash register/retail enterprise system 224 may be a hospitality PoS. In such embodiments, retail enterprise system 224 may include hospitality PoS software (e.g, Aloha PoS Restaurant software from NCR®, Micros® RES and Symphony software and the like), hospitality management software, and other hardware and software to facilitate hospitality operations.

Referring back to FIG. 1, transaction processor 103 may be configured to receive transaction data associated with a transaction. The account holder 106 may charge the transaction to a financial account with financial institution 101. The transaction may be a purchase made by account holder 106 at a POS location, such as merchant 107. The transaction may be an online purchase made at merchant 107. Account holder 106 may have made the purchase using one or more cards or NFC-equipped devices. The transaction may be an ATM withdrawal from an account with a financial institution, such as financial institution 101. The transaction data may be received from merchant 107, or financial institution 101, or account holder 106, or a third party, such as a payment processing entity. The transaction data may be received via network 108.

The transaction data may include the amount of the transaction, such as, for example, the amount to be charged to account holder 106's account or accounts. The transaction data may include a date and time of the transaction. The transaction data may include location information, such as geographical information associated with the physical location where the transaction was conducted. If the transaction is a purchase at a POS location or online, the transaction data may include a merchant identifier that identifies the merchant (such as merchant 107). The transaction data may include the category of merchant (clothing, electronics, restaurant, grocery store, hardware store, etc.).

Transaction processor may apply one or more spending limit rules to the transaction data. Transaction processor 103 may retrieve one or more spending limits associated with the account holder's financial account from financial institution 101. If the account is a credit account, the one or more spending limits may include a credit limit. The one or more spending limits may include an over-limit threshold. If the account is a debit account, the one or more spending limits may include the current account balance. The one or more spending limits for a debit account may include an over-limit threshold. So for example, if the account is a credit account with a credit limit of $10,000, the financial institution may impose an over-limit threshold of 10%. This would mean that the account holder may be allowed to exceed the credit limit by up to $1,000. The financial institution may apply an overdraft or over-limit fee if the account holder exceeds the credit limit but stays within the over-limit threshold.

The spending limits may be set by financial institution 101. The spending limits may be set by the account holder. The spending limits also may be applied to primary and/or secondary account holders. For example, the account holder may have set a daily spending limit which sets a maximum amount that the account holder 106 can charge to the account in a given day. The account holder or financial institution may have set a maximum transaction limit which sets a maximum amount that the account holder 106 can charge to the account in a single transaction.

In one example embodiment, account holder 106 may be a primary account holder who shares access to the account with one or more secondary account holders. For example, the primary account holder may be a father who has granted his son (secondary account holder) limited access to a credit account to use for school supplies. The primary account holder may designate spending limits that are applied only to the secondary account holder. For example, the father may limit the son's daily spending using the credit account to $15 per day. The father may limit the son's purchase categories to books and school supplies. The father may set a maximum transaction limit on the son's account at $100. The primary account holder may designate these one or more limits by accessing a website provided by financial institution 101, and/or by accessing his account on a mobile application provided by financial institution 101, or a third party.

Transaction processor 103 may compare the transaction amount to the one or more spending limits. Transaction processor 103 may compare the transaction amount to the available credit if the account is a credit account. Transaction processor 103 may compare the transaction amount to the account balance if the account is a debit account. If the transaction amount does not exceed the account balance/available credit, then transaction processor 103 may send the transaction data to fraud processor 104. In another embodiment, if the transaction was performed by a secondary account holder, the transaction processor 103 may compare the transaction amount to one or more spend limits that were pre-set by the primary account holder. If the transaction amount is less than the one or more pre-set spend limits, transaction processor 103 may send the transaction data to fraud processor 104. If the transaction amount is more than the one or more pre-set limits, transaction processor 103 may send the transaction data to account holder notifier 105.

If the transaction amount exceeds the available credit/account balance, then transaction processor 103 may apply one or more over-limit threshold rules to the transaction data. For example, if the financial account is a credit account, the financial account may have an over-limit threshold of 10%. If the credit limit for the account is $10,000, then the over-limit threshold would be an additional $1,000. If the transaction amount is less than (available credit/account balance+the over limit threshold), then the transaction processor may send the transaction data to account holder notifier 105. If the transaction amount is great than (available credit/account balance+over-limit threshold), then transaction processor 103 may deny the transaction and prevent the financial account from being charged for the transaction amount.

In one example, assume account holder A buys a digital TV at Best Buy using a credit account with Bank X. The credit account has a credit limit of $10,000, an over-limit threshold of 10%, and $2,000 in available credit. If the digital TV costs $2,500, transaction processor 103 will determine that user A has exceeded his available credit by $500. Transaction processor 103 may then determine that user A is within the over-limit threshold, because the transaction amount ($2,500) is less than the available credit+over-limit threshold: $2,000 (available credit) $1,000 (10% of $10,000). Transaction processor 103 may send the transaction data to account holder notifier 105.

In the preceding example, if the digital TV instead costs $3,500, transaction processor 103 may deny the transaction, because the transaction amount exceeds the sum of the available credit and over-limit threshold by $500.

Fraud processor 104 may apply one or more fraud algorithms to the transaction data. The one or more fraud algorithms may be configured to identify, indicate, or otherwise the transaction as potentially fraudulent. The fraud algorithms may compare the location of the transaction with the account holder's primary address (received from financial institution 101). If the difference between the transaction location and the account holder's primary address exceeds some maximum distance, fraud processor 104 may identify, indicate, or otherwise the transaction as potentially fraudulent by including a fraud indicator in the transaction data. The fraud algorithms may compare the type of transactions to the account holder's transaction history for one or more anomalies. For example, if the transaction is for a plane ticket to a foreign country, fraud processor 104 may identify, indicate, or otherwise the transaction as potentially fraudulent. In another example embodiment, the fraud algorithm may identify, indicate, or otherwise transactions where the financial account is charged for a cash advance that exceeds a maximum cash advance amount. The maximum cash advance amount may have been pre-set and may vary depending on the type of account and credit history of the account holder. These and other fraud algorithms may be used to identify, indicate, or otherwise transactions as potentially fraudulent.

If an attempted transaction is flagged as potentially fraudulent, for example, by fraud processor 104, it may be sent to account holder notifier 105. If an attempted transaction is not flagged as potentially fraudulent by fraud processor 104, then it may be approved for payment processing and the account may be charged the transaction amount.

Account holder notifier 105 may be configured to send one or more notifications to the account holder in response to receiving transaction data from fraud processor 104 and/or transaction processor 103. The notification may be one or more of an email, text message, SMS, Facebook message, Tweet, or other form of electronic communication. The notification may be sent to one or more of the account holder's mobile devices. The notification may include the transaction data. If the transaction was flagged as potentially fraudulent, the notification may include a message indicating that the transaction was flagged as potentially fraudulent. The notification may include the transaction amount, the transaction location, the date and time of the transaction, the name of the merchant or POS location where the transaction occurred, the type of transaction (e.g., purchase of goods and services, cash advance, withdrawal, fund transfer, etc.). If the transaction amount exceeds the available credit limit or account balance, the notification may include a message notifying the account holder of this. If any overdraft fees are associated, the notification may inform the account holder of the amount of overdraft fees that will be charged if the transaction is approved.

The notification may request a response from the account holder. The notification may include a link to a website operated by financial institution 101 or account holder notification system 102. Clicking on the link may direct account holder to a graphical user interface where he can review the transaction and approve it. The notification may simply ask the account holder to reply “approved,” “yes,” “no,” “not approved,” or some other short message to indicate whether the transaction is approved or not. The notification may be sent to a mobile application on the account holder's mobile device. The mobile application may include a graphical user interface where the account holder can view the notification and choose to respond.

Account holder notifier 105 may place a time limit on the notification. For example, if account holder notifier does not receive a response within 1 minute of sending the notification, account holder notifier 105 may deny the transaction. Other time limits may be used. If the account holder responds to the notification affirmatively, the response may be received by the account notifier 105, and the account notifier may approve the transaction. If the account holder responds to the notification disapproving the transaction, the response may be received by the account notifier 105, and the account notifier may deny the transaction.

The notification may include one or more security features. The notification may be encrypted. The notification may require the account holder to input a username and/or password to view the notification. The notification may require the account holder to input a username and/or password to respond to the notification. The notification may include a challenge question to verify the account holder's identity.

The aforementioned process may be conducted in real-time. For example, the process of notifying an account holder for approval of a transaction may be initiated as soon as the transaction is conducted. The notification may be received by the account holder in real-time.

FIG. 3 depicts an example system 300 that may enable a financial institution, for example, to provide network services to its customers. For example, system 300 may enable a financial institution to notify a user of an attempted transaction and allow the user to authorize the transaction in real-time using a mobile device or other client device. As shown in FIG. 3, system 300 may include a client device 302, a network 304, a front-end controlled domain 306, a back-end controlled domain 312, and a backend 318. Front-end controlled domain 306 may include one or more load balancers 308 and one or more web servers 310. Back-end controlled domain 312 may include one or more load balancers 314 and one or more application servers 316.

Client device 302 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 300 may execute one or more software applications to enable, for example, network communications.

Client device 302 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 304 may be one or more of a wireless network, a wired network, or any combination of a wireless network and a wired network. For example, network 304 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 304 may include, without limitation, telephone lines, fiber optics, IEEE Ethernet 902.3, a wide area network (WAN), a local area network (LAN) or a global network such as the Internet. Also, network 304 may support an Internet network, a wireless communication network, a cellular network, or the like, or any combination thereof. Network 304 may further include one network, or any number of example types of networks mentioned above, operating as a stand-alone network or in cooperation with each other. Network 304 may utilize one or more protocols of one or more network elements to which they are communicatively couples. Network 304 may translate to or from other protocols to one or more protocols of network devices. Although network 304 is depicted as a single network, it should be appreciated that according to one or more embodiments, network 304 may comprise a plurality of interconnected networks, such as, for example, the Internet, a service provider's network, a cable television network, corporate networks, and home networks.

Front-end controlled domain 306 may be implemented to provide security for backend 318. Load balancer(s) 308 may distribute workloads across multiple computing resources, such as, for example computers, a computer cluster, network links, central processing units or disk drives. In various embodiments, load balancer(s) 310 may distribute workloads across, for example, web server(S) 316 and/or backend 318 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 308 may include software that monitoring the port where external clients, such as, for example, client device 302, connect to access various services of a financial institution, for example. Load balancer(s) 308 may forward requests to one of the application servers 316 and/or backend 318 servers, which may then reply to load balancer 308. This may allow load balancer(s) 308 to reply to client device 302 without client device 302 ever knowing about the internal separation of functions. It also may prevent client devices from contacting backend servers directly, which may have security benefits by hiding the structure of the internal network and preventing attacks on backend 318 or unrelated services running on other ports, for example.

A variety of scheduling algorithms may be used by load balancer(s) 308 to determine which backend server to send a request to. Simple algorithms may include, for example, random choice or round robin. Load balancers 308 also may account for additional factors, such as a server's reported load, recent response times, up/down status (determined by a monitoring poll of some kind), number of active connections, geographic location, capabilities, or how much traffic it has recently been assigned.

Load balancers 308 may be implemented in hardware and/or software. Load balancer(s) 308 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 310 may include hardware (e.g., one or more computers) and/or software (e.g., one or more applications) that deliver web content that can be accessed by, for example a client device (e.g., client device 302) through a network (e.g., network 304), such as the Internet. In various examples, web servers, may deliver web pages, relating to, for example, online banking applications and the like, to clients (e.g., client device 302). Web server(s) 310 may use, for example, a hypertext transfer protocol (HTTP or sHTTP) to communicate with client device 302. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 310 may respond with the content of that resource or an error message if unable to do so. The resource may be, for example a file on stored on backend 318. Web server(s) 310 also may enable or facilitate receiving content from client device 302 so client device 302 may be able to, for example, submit web forms, including uploading of files.

Web server(s) also may support server-side scripting using, for example, Active Server Pages (ASP), PHP, or other scripting languages. Accordingly, the behavior of web server(s) 310 can be scripted in separate files, while the actual server software remains unchanged.

Load balancers 314 may be similar to load balancers 308 as described above.

Application server(s) 316 may include hardware and/or software that is dedicated to the efficient execution of procedures (e.g., programs, routines, scripts) for supporting its applied applications. Application server(s) 316 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 316 may act as a set of components accessible to, for example, a financial institution or other entity implementing system 300, through an API defined by the platform itself. For Web applications, these components may be performed in, for example, the same running environment as web server(s) 310, and application servers 316 may support the construction of dynamic pages. Application server(s) 316 also may implement services, such as, for example, clustering, fail-over, and load-balancing. In various embodiments, where application server(s) 316 are Java application servers, the web server(s) 316 may behaves like an extended virtual machine for running applications, transparently handling connections to databases associated with backend 318 on one side, and, connections to the Web client (e.g., client device 302) on the other.

Backend 318 may include hardware and/or software that enables the backend services of, for example, a financial institution or other entity that maintains a distributes system similar to system 300. For example, backend 318 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 318 also may include an account notification and authorization system as shown and described herein. Backend 318 may be associated with various databases, including account databases that maintain, for example, customer account information, product databases that maintain information about products and services available to customers, content databases that store content associated with, for example, a financial institution, and the like. Backend 318 also may be associated with one or more servers that enable the various services provided by system 100.

FIG. 4 provides an example method 400 for notifying an account holder based on received transaction data. The method 400 shown in FIG. 4 can be executed or otherwise performed by one or more combinations of various systems shown and described above. The method 400 as described below may be carried out by the system shown in FIGS. 1-3, by way of example, and various elements of that system are referenced in explaining the method of FIG. 4. Each block shown in FIG. 4 represents one or more processes, methods, or subroutines in the example method 400. Referring to FIG. 4, the example method 400 may begin at block 205.

At block 405, a transaction may be conducted or attempted using an account holder's account. The transaction may be a purchase made at a POS location, such as merchant 107. The transaction also may be an online purchase made using an e-commerce application and/or website associated with merchant 107. Account holder 106 may have made the purchase using one or more cards or NFC-equipped devices. The transaction may be an ATM withdrawal from an account with a financial institution, such as financial institution 101. The transaction or attempted transaction also may be, for example, a bill pay or online funds transfer made using, for example, a website and/or native application associated with a financial institution.

At block 410, transaction data may be reviewed. The transaction data may be received from financial institution 101, the merchant where the transaction was conducted, a third party payment processor, and/or some other like entity. Transaction data may include, for example, an account identifier or account number for the account used to conduct the transaction. The transaction data may include the amount of the transaction, such as, for example, the amount to be charged to and/or transferred from account holder 106's account or accounts. The transaction data may include a date and time of the transaction. The transaction data may include location information, such as geographical information associated with the physical location where the transaction was conducted. If the transaction is a purchase at a POS location or online, the transaction data may include a merchant identifier that identifies the merchant (such as merchant 107). The transaction data may include the category of merchant (clothing, electronics, restaurant, grocery store, hardware store, etc.). The transaction data also may include product description information including, for example, stock keeping unit (SKU) level data about the product(s) being purchased.

For example, account holder A may use a credit card to purchase a $300 car stereo at Best Buy in Richmond, Va. Transaction processor 103 may receive transaction data for this transaction, including the amount ($300), the merchant name (Best Buy), the category (electronics), the location (street, city, state, zip code, etc. of the merchant), the SKU for the stereo a date and time of the transaction, and/or any other like information that may describe the transaction.

At block 415, the transaction processor 103 may determine whether the account is active. Transaction processor may query financial institution 101 to determine if the account is an active account (using the account identifier or account number). For example, account information that identifies active accounts may be stored in a backend database associated with a financial institution. The financial institution backend may query this backend database to determine whether the account associated with the transaction and/or attempted transaction remains active. If the account is inactive, transaction processor may decline the transaction at block 455 and the process may end.

If the account is active, method 400 may proceed to block 420. At block 420, transaction processor 103 may compare the available credit balance on the account with the transaction amount (if the account is a credit account). For debit accounts, transaction processor 103 may compare the available account balance to the transaction amount. Continuing with the previous example, account holder A's current available credit may be $500. Transaction processor 103 may compare the transaction amount to the available credit. If the transaction amount exceeds the available credit, method 400 may proceed to block 425. If the transaction amount is less than the available credit, method 400 may proceed to block 430. In this example, the transaction amount ($300) is less than the available credit ($500), and thus the method 400 would proceed to block 430.

At block 425, the transaction processor 103 may determine whether the transaction amount exceeds the over-limit threshold. The over-limit threshold may be preset my the financial institution for the account. The over-limit threshold may be an amount that gives the account holder a certain flexibility to temporarily exceed a credit limit, rewards limit, or an account balance. Exceeding the credit limit may cause the financial institution to impose a fee on the account holder, such as an overdraft fee.

In the previous example, if account holder A instead had purchased a $1000 flat screen TV, the transaction amount would have exceeded the available credit and method 400 would have proceeded to block 425. In this example, financial institution 101 may have preset the over-limit threshold at 20% of the credit limit. Assuming the user A's credit limit was $10,000, this would mean the over-limit threshold is $2,000. If the transaction amount is within the over-limit threshold, method 400 may proceed to block 440. If the transaction amount exceeds the over-limit threshold, method 400 may proceed to block 455.

At block 430, fraud processor 104 may apply one or more fraud algorithms to the transaction data. In the previous example, assume account holder A's primary residence is in San Francisco, Calif. but he is visiting relatives in Richmond when he purchased the car stereo. Fraud processor 104 may include a fraud algorithm that compares the transaction location with the primary address of the account holder. If the difference between the two locations exceeds a maximum threshold, fraud processor may identify, indicate, or otherwise the transaction as potentially fraudulent at block 435 and method 400 may proceed to block 440. In this example, assume the maximum threshold is 1,000 miles. Fraud processor 104 may determine that the distance between San Francisco, Calif. and Richmond, Va. is more than 1,000 miles, and will accordingly identify, indicate, or otherwise the transaction as potentially fraudulent. Other fraud algorithms may be applied to the transaction, based on the transaction amount, transaction location, transaction type or category, date and time, and other relevant data. If fraud processor 104 applies the fraud algorithms and no fraud is detected, method 400 may proceed to block 450. If the transaction data is flagged as potentially fraudulent, method 400 may proceed to block 440.

At block 440, account holder notifier 105 may transmit a notification to the account holder. The notification may be one or more of an email, text message, SMS, Facebook message, Tweet, or other form of electronic communication. The notification may be sent to one or more of the account holder's mobile devices. The notification may include the transaction data. If the transaction was flagged as potentially fraudulent in block 435, the notification may include a message indicating that the transaction was flagged as potentially fraudulent. The notification may include the transaction amount, the transaction location, the date and time of the transaction, the name of the merchant or POS location where the transaction occurred, the type of transaction (e.g., purchase of goods and services, cash advance, withdrawal, fund transfer, etc.). If the transaction amount exceeds the available credit limit or account balance (based on steps 220 and 225), the notification may include a message notifying the account holder of this. If any overdraft fees are associated, the notification may inform the account holder of the amount of overdraft fees that will be charged if the transaction is approved.

The notification may be time-limited. If account holder notifier 105 does not receive a response within a predetermined time, method 400 may automatically proceed to block 455. In the previous example, account holder A's car stereo purchase was flagged as potentially fraudulent in block 435. Account notifier 105 may send a text message to account holder A's mobile device notifying him of the potentially fraudulent transaction. The text message may include the location of the transaction (Best Buy in Richmond, Va.), the amount ($300), the date and time, the good purchased (car stereo), and other relevant information. Additionally, or alternatively, the notification may be provided on a mobile application on account holder A's mobile device. The notification may request a response from account holder A approving or denying the transaction. Account holder notifier 105 may place an expiration-limit or time-limit of 5 minutes. If account holder A does not reply to the notification within five minutes, the transaction may be automatically denied at block 455.

At block 445, account holder notifier 105 may receive a response from the account holder. The notification may request a response from the account holder. The notification may include a link to a website operated by financial institution 101 or account holder notification system 102. Clicking on the link may direct account holder A to a graphical user interface where he can review the transaction and approve it. The notification may simply ask the account holder to reply “approved,” “yes,” “no,” “not approved,” or some other short message to indicate whether the transaction is approved or not. If account holder A approves the transaction, method 400 may proceed to block 250. If account holder A denies the transaction, method 400 may proceed to block 255.

For example, the notification may include a GUI with a check box next to “approved” and a check box next to “denied.” If account holder A checks “approved,” and sends the notification back, the $300 transaction will be approved and charged to the credit account, per block 450. If account holder A checks “denied” and send the notification back, the $300 transaction will be denied per block 455.

The notification may include one or more security features. The notification may be encrypted. The notification may require the account holder to input a username and/or password to view the notification. The notification may require the account holder to input a username and/or password to respond to the notification. The notification may include a challenge question to verify the account holder's identity.

FIG. 5 provides an example method 500 for notifying a primary account holder based on received transaction data related to a secondary account holder. The method 500 shown in FIG. 5 can be executed or otherwise performed by one or more combinations of various systems. The method 500 as described below may be carried out by the system shown in FIG. 1, by way of example, and various elements of that system are referenced in explaining the method of FIG. 5. Each block shown in FIG. 5 represents one or more processes, methods, or subroutines in the example method 500. Referring to FIG. 5, the example method 400 may begin at block 310.

At block 510, a transaction may be conducted or attempted using a primary account holder's account. The transaction may be a purchase made at a POS location, such as merchant 107. The transaction also may be an online purchase made using an e-commerce application and/or website associated with merchant 107. A secondary account holder may have made the purchase using one or more cards or NFC-equipped devices. The transaction may be an ATM withdrawal from an account with a financial institution, such as financial institution 101. The transaction or attempted transaction also may be, for example, a bill pay or online funds transfer made using, for example, a website and/or native application associated with a financial institution.

At block 515, transaction data may be reviewed. The transaction data may be received from financial institution 101, the merchant where the transaction was conducted, a third party payment processor, or some other entity. Transaction data may include an account identifier or account number for the account used to conduct the transaction. The transaction data may include the amount of the transaction, such as, for example, the amount to be charged to primary account holder 106's account or accounts. The transaction data may include a date and time of the transaction. The transaction data may include location information, such as geographical information associated with the physical location where the transaction was conducted. If the transaction is a purchase at a POS location or online, the transaction data may include a merchant identifier that identifies the merchant (such as merchant 107). The transaction data may include the category of merchant (clothing, electronics, restaurant, grocery store, hardware store, etc.).

For example, account holder A may be the primary account holder for a credit account. He may share access to the account with his son, B, who would be designated as a secondary account holder. B may be a student and account holder A may allow B to have a credit card for school-related purchases. Account holder B may use his credit card to attempt to purchase a $500 laptop at a Wal-Mart in Alexandria, Va. Transaction processor 103 may receive transaction data for this transaction, including the amount ($500), the merchant name (Wal-Mart), the category (electronics), the location (street, city, state, zip code, etc. of the merchant), and a date and time of the transaction.

At block 520, the transaction processor 103 may determine whether the account is active. Transaction processor may query financial institution 101 to determine if the account is an active account (using the account identifier or account number). If the account is inactive, transaction processor may decline the transaction at block 570 and the process may end.

If the account is active, method 500 may proceed to block 525. At block 525, transaction processor 103 may compare the available credit balance on the account with the transaction amount (if the account is a credit account). For debit accounts, transaction processor 103 may compare the available account balance to the transaction amount. Continuing with the previous example, the available credit may be $500. Transaction processor 103 compare the transaction amount to the available credit. If the transaction amount exceeds the available credit, method 400 may proceed to block 565. If the transaction amount is less than or equal to the available credit, method 500 may proceed to block 530. In this example, the transaction amount ($500) is less than or equal to the available credit ($500), and thus the method 500 would proceed to block 530.

At block 565, the transaction processor 103 may determine whether the transaction amount exceeds the over-limit threshold. This process is identical to block 425 in FIG. 4.

At steps 330 and 335, transaction processor 103 may apply one or more preset spending limits to the transaction data. The preset spending limits may have been previously provided by primary account holder A. The preset spending limits may include a category limit. For example, account holder A may have preset spending limits on the credit account so that it can only be used for purchasing food and school supplies. The preset spending limits may include a daily spending limit. For example, account holder A may have preset a daily spending limit of $50 for the credit account. The preset spending limits may include a transaction spending limit. For example, account holder A may have preset a transaction limit of $100 for the credit account. Although method 500 only shows two spending limits being applied to the transaction data, other spending limits may be enforced, depending on how the primary account holder has configured the account.

At block 530, because the transaction amount ($500) is over the preset daily limit ($50), the transaction data would be sent to the account holder notifier 105 at block 550. Alternatively or additionally, if the transaction amount ($500) is compared to the single transaction limit ($100) at block 535, the transaction data would be sent to the account holder notifier 105 at block 550.

If the transaction data does not violate the one or more preset limits, method 500 may proceed to block 540. Steps 340 and 345 apply one or more fraud algorithms to the transaction data. These steps are similar to steps 230 and 235 in FIG. 4.

At block 550, account holder notifier 105 may transmit a notification to the primary account holder. The notification may be an email, text, SMS, Facebook message, Tweet, or other form of electronic communication. The notification may be sent to one or more of the primary account holder's mobile devices. The notification may include the transaction data. If the transaction was flagged as potentially fraudulent in block 545, the notification may include a message indicating that the transaction was flagged as potentially fraudulent. The notification may include the transaction amount, the transaction location, the date and time of the transaction, the name of the merchant or POS location where the transaction occurred, the type of transaction (e.g., purchase of goods and services, cash advance, withdrawal, fund transfer, etc.), and information on what was purchased. If the transaction amount exceeds the available credit limit or account balance (based on steps 325 and 365), the notification may include a message notifying the primary account holder of this. If any overdraft fees are associated, the notification may inform the primary account holder of the amount of overdraft fees that will be charged if the transaction is approved.

If the transaction data was flagged for failing to meet one or more of the preset limits (such as those shown in steps 330 and 335), the notification may include this information and inform the primary account holder of this.

The notification may also be sent to secondary account holder. The notification may include all of the information provided to the primary account holder, but may not request a response to approve or deny the transaction. In other embodiments, the primary account holder may have previously designated the secondary account holder as having authority to approve or deny transactions in the same way the primary account holder can.

The notification may be time-limited. If account holder notifier 105 does not receive a response within a predetermined time, method 500 may automatically proceed to block 570. In the previous example, account holder B's laptop purchase failed to meet the preset daily limit in block 530. Account notifier 105 may send a text message to primary account holder A's mobile device notifying him of this. The text message may include the location of the transaction (Alexandria, Va.), the merchant name (Wal-Mart), the amount ($500), the date and time, the good purchased (laptop), and other relevant information. Additionally, or alternatively, the notification may be provided on a mobile application on primary account holder A's mobile device. The notification may request a response from account holder A approving or denying the transaction. Account holder notifier 105 may place an expiration-limit or time-limit of 5 minutes. If account holder A does not reply to the notification within five minutes, the transaction may be automatically denied at block 570.

At block 555, account holder notifier 105 may receive a response from the primary account holder. The notification may have requested a response from the primary account holder. The notification may include a link to a website operated by financial institution 101 or account holder notification system 102. Clicking on the link may direct primary account holder A to a graphical user interface where he can review the transaction and approve it. The notification may simply ask the account holder to reply “approved,” “yes,” “no,” “not approved,” or some other short message to indicate whether the transaction is approved or not. If account holder A approves the transaction, method 500 may proceed to block 360. If account holder A denies the transaction, method 500 may proceed to block 370.

For example, the notification may include a GUI with a check box next to “approved” and a check box next to “denied.” If primary account holder A checks “approved,” and sends the notification back, the $500 transaction will be approved and charged to the credit account, per block 560. If account holder A checks “denied” and send the notification back, the $500 transaction will be denied per block 570.

The notification may include one or more security features. The notification may be encrypted. The notification may require the account holder to input a username and/or password to view the notification. The notification may require the account holder to input a username and/or password to respond to the notification. The notification may include a challenge question to verify the account holder's identity.

Other examples of primary account holders may include business owners or managers, guardians, supervisors, or others in an authority relationship. A secondary account holder may be an employee. A secondary account holder may be a ward.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
a transaction data communication module that receives, via a network, transaction data associated with a transaction;
a transaction processor that associates the transaction data with an account of an account holder, compares the transaction data to one or more spending limits associated with the account, and compares the transaction data to one or more fraud detection rules associated with the account;
an account holder notification system associated with the transaction processor that notifies the account holder, via a network, based on the results of the comparison steps; and
an authorization response module that receives, via a network, a response from the account holder and approves or deny the transaction based at least in part on a response received.

2. The system of claim 1, wherein the account holder notification system is communicatively coupled to a short message service (SMS) network and the account holder notification system notifies the account holder via a SMS message.

3. The system of claim 1, wherein the account holder notification system is communicatively coupled to an email messaging system and the account holder notification system notifies the account holder via email.

4. The system of claim 1, wherein the account holder notification system cooperates with a native application to notify the account holder via the native application.

5. The system of claim 1, wherein the account holder notification system notifies the account holder in real time.

6. The system of claim 5, wherein the account holder notification system transmits an authorization request to a mobile device of the account holder via a network.

7. The system of claim 1, wherein the transaction data communication module receives the transaction data via an authorization network.

8. The system of claim 1, wherein the account is associated with a financial institution.

9. The system of claim 8, wherein the account is a credit or debit account.

10. The system of claim 1, wherein the transaction data is associated with a purchase transaction.

11. A method, comprising:
receiving, via a network, transaction data associated with a transaction;
associating, using a transaction processor, the transaction data with an account of an account holder;
comparing, using the transaction processor, the transaction data to one or more spending limits associated with the account;
comparing, using the transaction processor, the transaction data to one or more fraud detection rules associated with the account;
notifying, using an account holder notification system, the account holder, via a network, based on the results of the comparison steps; and
receiving, via a network, a response from the account holder;
approving or denying the transaction based at least in part on a response received.

12. The method of claim 11, wherein the account holder notification system is communicatively coupled to a short message service (SMS) network and the method further comprises notifying the account holder via a SMS message.

13. The method of claim 11, wherein the account holder notification system is communicatively coupled to an email messaging system and the method further comprises notifying the account holder via email.

14. The method of claim 11, wherein the account holder notification system cooperates with a native application and the method further comprises notifying the account holder via the native application.

15. The method of claim 11, further comprising notifying the account holder in real time.

16. The method of claim 15, further comprising transmitting an authorization request to a mobile device of the account holder via a network.

17. The method of claim 11, further comprising receives the transaction data via an authorization network.

18. The method of claim 11, wherein the account is associated with a financial institution.

19. The method of claim 18, wherein the account is a credit or debit account.

20. The method of claim 11, wherein the transaction data is associated with a purchase transaction.
